(19) United States
(12) Patent Application Publication
(10) Pub. No.: US 2026/0118027 A1
(43) Pub. Date: Apr. 30, 2026

(54) REFRIGERANT MANIFOLD

(71) Applicant: Hanon Systems, Daejeon (KR)

(72) Inventors: Sangyong RHEE, Daejeon (KR); Da Won LEE, Daejeon (KR)

(73) Assignee: Hanon Systems, Daejeon (KR)

(21) Appl. No.: 19/123,660

(22) PCT Filed: Nov. 1, 2023
(86) PCT No.: PCT/KR2023/017200

§ 371 Date: Apr. 23, 2025

(30) Foreign Application Priority Data
Nov. 3, 2022 (KR) 10-2022-0145138
Oct. 26, 2023 (KR) 10-2023-0144684

(51) Int. Cl. F25B 41/42; F25B 39/04; F25B 41/20; F25B 41/31

(52) U.S. Cl. CPC F25B 41/42; F25B 39/04; F25B 41/20; F25B 41/31; F25B 2339/047

(57) ABSTRACT

The present invention relates to a refrigerant manifold to be applied to a vehicle cooling system, and relates to a refrigerant manifold which has refrigerant ports disposed at the outermost side of a manifold body such that installation and assembly convenience of pipes and hoses for connection to a refrigerant module and other components of a heat exchange system may be improved, and which facilitates accessibility of the refrigerant ports so that workability may be improved.

### TECHNICAL FIELD

The present invention relates to a refrigerant manifold applied to a vehicle cooling system, and more particularly, to a refrigerant manifold in which a refrigerant port is disposed on the outermost side of a manifold body to enhance connectivity and workability.

### BACKGROUND ART

Recently, as interest in energy efficiency and environmental pollution issues has grown, there has been a demand for the development of an eco-friendly vehicle that may practically replace an internal combustion engine vehicle, and the eco-friendly vehicles may usually be categorized into an electric vehicle powered by a fuel cell or electricity and a hybrid vehicle powered by an engine and a battery.

Among these eco-friendly vehicles, the electric vehicle or the hybrid vehicle does not use a separate heater, unlike an air conditioning device of a general vehicle, and an air conditioning system applied to the eco-friendly vehicle is usually referred to as a heat pump system.

Meanwhile, in the electric vehicle, chemical reaction energy of oxygen and hydrogen may be converted into electrical energy to generate a driving force. During this process, heat energy may occur due to a chemical reaction within the fuel cell, and effectively removing the occurring heat is thus essential for securing the performance of the fuel cell.

In addition, in the hybrid vehicle, along with the engine operated using a general fuel, the driving force may be generated by driving a motor using electricity supplied from the fuel cell or an electric battery, and the performance of the motor may thus be secured only when heat occurring in the fuel cell, the battery, or the motor is effectively removed.

Accordingly, in the hybrid vehicle or the electric vehicle according to a prior art, a cooling system and the heat pump system, as well as a battery cooling system, need to be configured as separate sealed circuits to prevent the heat occurrence in the battery including the motor, electrical components, and the fuel cell.

This configuration may result in an increased size or weight of a cooling module disposed at the front of the vehicle and a complicated layout of connection pipes supplying a refrigerant or a coolant to each of the heat pump system, cooling means, and battery cooling system inside an engine room.

This application cites Korean Patent Laid-Open Publication No. 10-2019-0068125 (published on Jun. 18, 2019) as a related art document.

### DISCLOSURE

### Technical Problem

An object of the present invention is to provide a refrigerant manifold in which a refrigerant port is disposed on the outermost side of a manifold body to enhance connectivity and workability.

### Technical Solution

In one general aspect, a refrigerant manifold includes: a manifold body having components mounted thereon and including a refrigerant channel formed therein through which a refrigerant flows; and a refrigerant port communicating with the refrigerant channel to introduce the refrigerant from the outside or discharge the refrigerant to the outside, wherein at least one of the refrigerant ports is disposed on an outermost side of the manifold body.

The manifold body may have a plate-like shape, a component mounting structure for mounting the components may be formed on each of one surface and the other surface of the manifold body, an engraved structure forming the refrigerant channel may be formed on n an inner surface of the manifold body, and the refrigerant port may be disposed on a surface other than the surface on which the refrigerant channel is formed.

The manifold body may include a first housing, a central plate, and a second housing, each having a plate-like shape, and the first housing, the central plate, and the second housing may be sequentially stacked.

The central plate may be a flat plate having one flat surface and the other flat surface, the engraved structure forming the refrigerant channel may be formed on each of an inner side of the first housing and an inner side of the second housing, and the refrigerant channels may be formed between the first housing and the central plate, and between the second housing and the central plate.

The component mounting structures for mounting the components may be disposed on an outer side of the first housing, which is the one surface of the manifold body, and an outer side of the second housing, which is the other surface of the manifold body, respectively.

The central plate may include at least one through hole passing through the central plate, and a first refrigerant channel and a second refrigerant channel may communicate with each other through the through hole in the central plate if, among the refrigerant channels, the refrigerant channel formed between the first housing and the central plate is referred to as the first refrigerant channel, and the refrigerant channel formed between the second housing and the central plate is referred to as the second refrigerant channel.

The through hole in the central plate may enable a direct flow of the refrigerant between a first component and a second component if, among the components, the component mounted on an outer side of the first housing, which is the one surface of the manifold body, is referred to as the first component, and the component mounted on an outer side of the second housing, which is the other surface of the manifold body, is referred to as the second component.

The first housing may include a fifth refrigerant port and a sixth refrigerant port, the second housing may include a first refrigerant port, a second refrigerant port, a third refrigerant port, and a fourth refrigerant port, and a port hole in the first refrigerant port may have a larger diameter than any of port holes in the second to sixth refrigerant ports.

The sixth refrigerant port may be disposed at a lowest position among the refrigerant ports in a direction of gravity.

At least some of the refrigerant ports may have the port holes in the refrigerant ports that are open in a direction perpendicular to a direction in which the manifold bodies are stacked.

The refrigerant port may include more port holes that are open in a direction parallel to a stacking direction of the manifold bodies than the port holes in the refrigerant port that are open in a direction perpendicular to the stacking direction of the manifold bodies.

In another general aspect, a refrigerant module includes: a refrigerant manifold; and components mounted on and coupled to the refrigerant manifold, wherein the components include an expansion valve, a water-cooled condenser, a chiller, and a heat pump valve, the plurality of expansion valves are provided, each expansion valve being mounted on one surface of the refrigerant manifold, and the water-cooled condenser, the chiller, and the heat pump valve are mounted on the other surface of the refrigerant manifold.

A direction in which the refrigerant manifolds are stacked may be perpendicular to a direction of gravity.

The water-cooled condenser and the chiller may be disposed on one side of the refrigerant manifold, a multi-way valve may be disposed on the other side, and the multi-way valve may be coupled to the expansion valve.

The water-cooled condenser may be disposed on the refrigerant manifold to allow a length direction of the water-cooled condenser to be oriented from an upper side to a lower side in the direction of gravity.

The multi-way valve may include the plurality of multi-way valves, the refrigerant manifold may include a plurality of refrigerant ports, and one of the plurality of refrigerant ports may be disposed around one of the plurality of multi-way valves.

Among the plurality of multi-way valves, a fifth refrigerant port among the plurality of refrigerant ports is disposed around a third valve accommodation part among valve accommodation parts respectively accommodating the plurality of multi-way valves

### Advantageous Effects

According to the present disclosure, as the refrigerant port is disposed on the outermost side of the manifold body, when the heat exchange system is configured by mounting the refrigerant module on the vehicle, the installation and assembly convenience of the pipes and hoses for connecting the refrigerant module to other components of the heat exchange system may be improved, and the accessibility of the refrigerant port may be facilitated, thus enhancing the workability.

In addition, the integrated structure of the refrigerant port into the housing may reduce the connection length between the pipe and the hose, thereby reducing the complexity of the pipe connection, simultaneously increasing the connection stability, and may reduce the total number of components and the assembly work by minimizing the use of the pipe and the hose.

### DESCRIPTION OF DRAWINGS

FIG. 1 is a view showing a refrigerant module according to an embodiment of the present disclosure.

FIG. 2 is an exploded perspective view of the refrigerant module.

FIG. 3 is an exploded perspective view of the refrigerant manifold according to an embodiment of the present disclosure.

### DESCRIPTION OF REFERENCE NUMERALS

10: refrigerant module
100: refrigerant manifold
110: manifold body
115: refrigerant channel
110A: first housing
110B: the central plate
110C: the second housing
120: refrigerant port
200: component

### BEST MODEL

Hereinafter, the present disclosure is described with reference to the accompanying drawings.

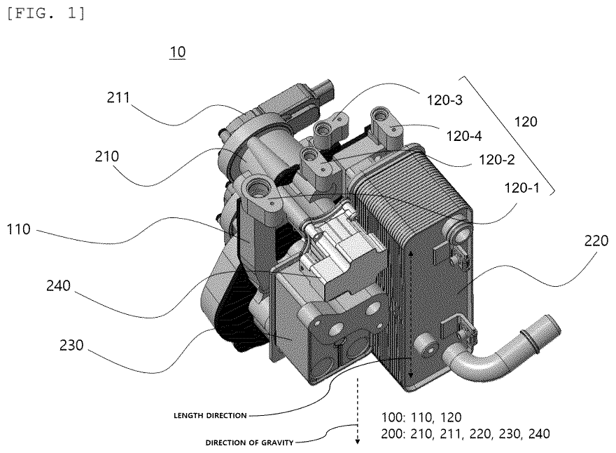

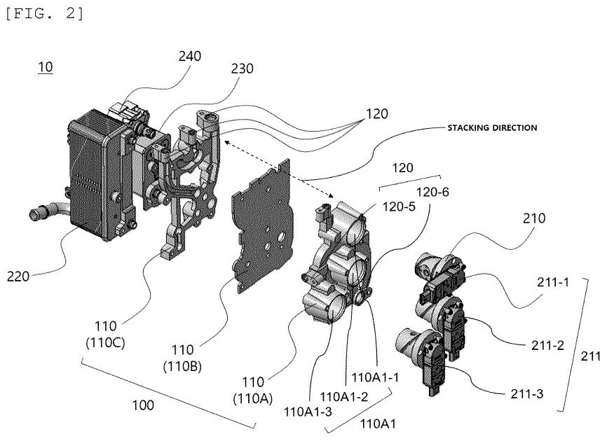

FIG. 1 is a view showing a refrigerant module according to an embodiment of the present disclosure, and FIG. 2 is an exploded perspective view of the refrigerant module. A refrigerant module 10 according to the present disclosure may broadly include a refrigerant manifold 100 and components 200 mounted on and coupled to the refrigerant manifold.

In the present disclosure, each of the components 200 may be integrated around the refrigerant manifold 100, and the refrigerant manifold 100 may provide a mounting space for mounting each of the components 200, and include a refrigerant channel in which a refrigerant may flow.

The components 200 may correspond to components of a vehicle cooling system, and in the present disclosure, the respective components may include an expansion valve 210, a water-cooled condenser 220, a chiller 230, and a heat pump valve 240. The plurality of expansion valves 210 may be provided, and a multi-way valve 211 may be coupled to one side of the expansion valve 210.

Here, the multi-way valve 211 may be configured as a three-way valve. Referring to FIG. 1, the multi-way valve 211 may include a first multi-way valve 211-1, a second multi-way valve 211-2, and a third multi-way valve 211-3. In addition, the multi-way valve 211 may be accommodated in a valve accommodation part 110A1 included in a first housing 110A. The valve accommodation part 110A1 may include a first valve accommodation part 110A1-1, a second valve accommodation part 110A1-2, and a third valve accommodation part 110A1-3. The first valve accommodation part 110A1-1 may accommodate the first multi-way valve 211-1, the second valve accommodation part 110A1-2 may accommodate the second multi-way valve 211-2, and the third valve accommodation part 110A1-3 may accommodate the third multi-way valve 211-3.

The expansion valve is a valve that reduces a pressure of a liquid-phase refrigerant and vaporizes the same, the water-cooled condenser is a heat exchanger that condenses a gas-phase refrigerant into a liquid-phase refrigerant, and the chiller is a heat exchanger that removes heat from the liquid-phase refrigerant. In an air-cooled condenser (not shown), the refrigerant may be sub-cooled.

The respective components 200 may be mounted on the refrigerant manifold 100 to form the refrigerant module 10. Here, the respective components 200 may be mounted to communicate with the refrigerant channel formed inside the refrigerant manifold 100. In more detail, the respective components 200 may be disposed on the refrigerant manifold 100 and mounted to communicate with a mounting structure corresponding to each of the components among the mounting structures that communicate with the refrigerant channel, thereby communicating with the refrigerant channel.

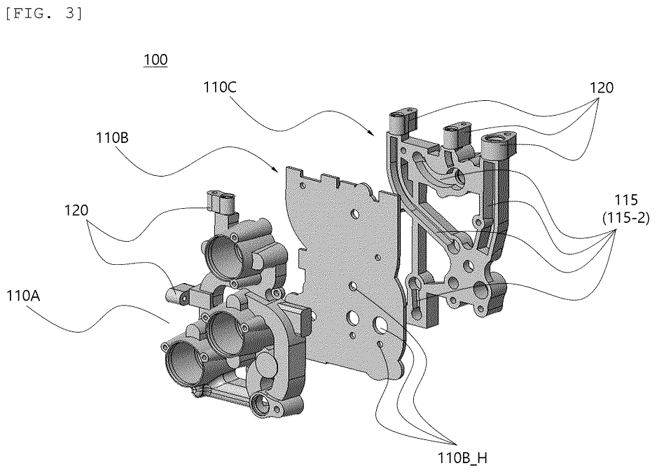

Hereinafter, the description first describes the refrigerant manifold 100 according to the present disclosure. FIG. 3 is an exploded perspective view of the refrigerant manifold according to an embodiment of the present disclosure, and as shown in the drawing, the refrigerant manifold may broadly include a manifold body 110 and a refrigerant port 120.

The manifold body 110 may have components 200 mounted thereon, and include a refrigerant channel 115 formed therein through which the refrigerant flows. In more detail, a component mounting structure for mounting the components described above may be disposed on an outer side of the manifold body 110, and the components mounted in the corresponding component mounting structure may communicate with the refrigerant channel to thus form a refrigerant circuit.

In addition, the refrigerant port 120 may communicate with the refrigerant channel 115 to introduce the refrigerant from the outside or to discharge the refrigerant to the outside, and may correspond to a refrigerant inlet or a refrigerant outlet. The plurality of refrigerant ports 120 may be provided, some of the refrigerant ports 120 may correspond to the refrigerant inlet and the others may correspond to the refrigerant outlet.

Here, in the refrigerant manifold 100 according to the present disclosure, the refrigerant port 120 may be disposed on the outermost side of the manifold body 110 as shown in the drawing.

In more detail, referring back to FIG. 3, the manifold body 110 may have an entirely plate-like shape, and include the mounting structure for mounting the components 200, which is formed on each of one surface and the other surface of the manifold body 110, that is, the front and rear surfaces of the manifold body 110 in the drawing.

In this way, as the refrigerant port 120 is disposed on the outermost side of the manifold body, when a heat exchange system is configured by mounting the above-described refrigerant module 10 on a vehicle, the installation and assembly convenience of pipes and hoses for connecting the refrigerant module to the other components of the heat exchange system may be improved, and the accessibility of the refrigerant port may be facilitated, thus enhancing workability.

When the plurality of refrigerant ports 120 are provided, each of the plurality of refrigerant ports 120 may be disposed on the outermost side of the manifold body 110, and the above-described advantages may thus be highlighted.

Furthermore, the refrigerant port 120 may have a flange structure that protrudes outwardly from the manifold body 110 by a predetermined length, and the refrigerant port 120 having the flange structure may include an inlet/outlet through which the refrigerant is introduced or discharged by communicating with the refrigerant channel 115 and a connection hole passing through the refrigerant port 120 to be connected to the pipe or the hose. The refrigerant port 120 may have the flange structure in this way, thereby further enhancing connectivity between the refrigerant port and the pipe or the hose.

Next, the structure of the manifold body 110 according to the present disclosure is described in more detail as follows.

In the manifold body 110, at least two or more plates may be stacked. In more detail, referring back to FIG. 3, the manifold body 110 may include the plate-shaped first housing 110A, a plate-shaped central plate 110B, and a plate-shaped second housing 110C, and the first housing 110A, the central plate 110B, and the second housing 110C may be sequentially stacked. The first housing 110A, the central plate 110B, and the second housing 110C may be bolted to one another, and may be simultaneously or separately bolted to each other through bolting holes respectively formed in the first housing 110A, the central plate 110B, and the second housing 110C.

The central plate 110B may be a flat plate having one flat surface and the other flat surface, and an engraved structure forming the refrigerant channel 115 described above may be formed on each of an inner side of the first housing 110A and an inner side of the second housing 110C. Here, the inner side of the first housing 110A may indicate a space between the first housing 110A and the central plate 110B, and the inner side of the second housing 110C may indicate a space between the second housing 110C and the central plate 110B.

In this structure, the central plate 110B may be stack-coupled to one surface of the first housing 110A (i.e., rear surface in the drawing) to close an open portion of the engraved structure formed on the inner side of the first housing 110A, thereby forming a complete first refrigerant channel 115-1 (not shown in the drawing) between the first housing 110A and the central plate 110B; and the central plate 110B may be stack-coupled to one surface of the second housing 110C (i.e., front surface in the drawing) to close an open portion of the engraved structure formed on the inner side of the second housing 110C, thereby forming a complete second refrigerant channel 115-2 between the second housing 110C and the central plate 110B.

That is, the refrigerant channel 115 may include the first refrigerant channel 115-1 formed between the first housing 110A and the central plate 110B, and the second refrigerant channel 115-2 formed between the second housing 110C and the central plate 110B, and each of the first refrigerant channel 115-1 and the second refrigerant channel 115-2 may include a plurality of unit refrigerant channels.

In addition, as described above, the mounting structure for mounting the components 200 may be formed on an outer side of the first housing 110A, which is one surface of the manifold body 110 (i.e., front surface in the drawing), the mounting structure for mounting the components 200 may be formed on an outer side of the second housing 110C, which is the other surface of the manifold body 110 (i.e., rear surface in the drawing), and the plurality of refrigerant ports 120 may be provided.

As the refrigerant port 120 is integrated with the first housing 110A and the second housing 110C, a connection length between the pipe and hose may be reduced, thereby reducing complexity of a pipe connection and simultaneously increasing connection stability. Furthermore, the use of pipes and hoses may be minimized to reduce a total number of components and an assembly work, required to construct the heat exchange system.

In detail, the six refrigerant ports 120 may be provided. The first housing 110A may include a fifth refrigerant port 120-5 and a sixth refrigerant port 120-6, and the second housing 110C may include a first refrigerant port 120-1, a second refrigerant port 120-2, a third refrigerant port 120-3, and a fourth refrigerant port 120-4.

The first refrigerant port 120-1 may introduce the gas-phase refrigerant from an evaporator to the refrigerant manifold. The second refrigerant port 120-2 may introduce a compressed refrigerant from a compressor to the refrigerant manifold. The third refrigerant port 120-3 may discharge the refrigerant from the refrigerant manifold to the evaporator. The fourth refrigerant port 120-4 may introduce the refrigerant from an air-cooled condenser disposed outside the refrigerant module (disposed at the front of the vehicle) to the refrigerant manifold. The fifth refrigerant port 120-5 may discharge the refrigerant from the refrigerant manifold to the air-cooled condenser. The sixth refrigerant port 120-6 may discharge the refrigerant from the refrigerant manifold to a vapor-liquid separator.

The refrigerant port 120 may include a port hole for connecting the pipes through which the refrigerant flows. Here, the port hole in the first refrigerant port 120-1 may have a larger diameter than any of the port holes in the second to sixth refrigerant ports 120-2 to 120-6. The first refrigerant port 120-1 may be the refrigerant port through which the gas-phase refrigerant is introduced from the evaporator to the refrigerant manifold 100. The port hole in the first refrigerant port 120-1 may preferably be formed to have a large diameter to prevent an increase in the pressure of the refrigerant introduced into the compressor.

In addition, the refrigerant port 120-6 may be the refrigerant port through which the refrigerant flows from the refrigerant manifold 100 to the vapor-liquid separator. The refrigerant that passes through the evaporator may include a large amount of liquid-phase refrigerant. The vapor-liquid separator may separate the liquid-phase refrigerant and the gas-phase refrigerant from a refrigerant mixture of liquid and gas phases. The vapor-liquid separator may filter out the liquid-phase refrigerant and send only the gas-phase refrigerant to the compressor. Here, the refrigerant port 120-6 may be disposed immediately before the vapor-liquid separator, and thus include the large amount of liquid refrigerant. The sixth refrigerant port 120-6 may preferably be disposed at the lowest position among the refrigerant ports 120 in the direction of gravity.

A placement position of the sixth refrigerant port 120-6 may prevent the liquid-phase refrigerant from flowing down in an internal channel of the refrigerant manifold 100 in the direction of gravity and being introduced into the refrigerant channel and the components disposed at the bottom.

At least some of the refrigerant ports 120 may have the port holes in the refrigerant ports 120 that are open in a direction perpendicular to a direction in which the manifold bodies 110 are stacked. Here, the sixth refrigerant port 120-6 is shown to be disposed in a direction parallel to the stacking direction of the manifold bodies 110.

In addition, the refrigerant port 120 may include more port holes that are open in the direction parallel to the stacking direction of the manifold bodies 110 than the port holes in the refrigerant port that are open in the direction perpendicular to the stacking direction of the manifold bodies 110.

The refrigerant manifolds may each have a plate shape and be stacked. If there are many refrigerant ports having the port holes that are open in the direction parallel to the stacking direction, the refrigerant manifold may interfere with the components mounted on the refrigerant manifold, thus making a manifold area unnecessarily large to avoid the interference. The refrigerant module is intended to compactly miniaturize/modularize the pipes and components required for a refrigerant system. Accordingly, most of the refrigerant ports may be arranged at the outermost end in a direction perpendicular to the stacking direction in order to efficiently arrange the plurality of refrigerant ports within the limited refrigerant manifold area.

Referring back to FIG. 3, the central plate 110B may include a plurality of through holes 110B H passing through the central plate 110B.

In addition, at least some of the corresponding through holes 110B_H may be through holes for connecting the first refrigerant channel 115-1 to the second refrigerant channel 115-2 described above, through which the first refrigerant channel 115-1 and the second refrigerant channel 115-2 may be connected to each other. The first refrigerant channel and the second refrigerant channel may be connected to each other through the through hole, thereby enabling a flexible design of a refrigerant flow line inside the refrigerant manifold, and the first refrigerant channel and the second refrigerant channel may be connected to each other without any additional structure, thereby increasing a space usage.

In addition, at least some of the plurality of through holes 110B_H may be through holes that directly connect a first component to a second component, thereby enabling a direct flow of the refrigerant between the first component and the second component. Here, the first component may indicate a component mounted on the outer side of the first housing, which is one surface of the manifold body (i.e., front surface in the drawing), and the second component may indicate a component that is mounted on the outer side of the second housing, which is the other surface of the manifold body (i.e., rear surface in the drawing). In this way, the first component and the second component may be directly connected to each other through the through hole to thus reduce the number of refrigerant channels required for the connection between the components, thereby forming a simpler structure of the refrigerant manifold.

In addition, at least some of the plurality of through holes 110B_H may correspond to the bolting holes described above, through which the first housing 110A, the central plate 110B, and the second housing 110C may be bolted to one another, as described above.

Hereinafter, the refrigerant module 10 according to the present disclosure is described. Referring back to FIGS. 1 and 2, the refrigerant module 10 may include the refrigerant manifold 100 described above and the components 200 mounted on and coupled to the refrigerant manifold 100.

In a specific embodiment, the plurality of expansion valves may be mounted on one surface of the refrigerant manifold (i.e., front surface in the drawing), and the water-cooled condenser, the chiller, and the heat pump valve may be mounted on the other surface of the refrigerant manifold (i.e., rear surface in the drawing). The refrigerant manifold may be a structure erected vertically in the direction of gravity, and the expansion valve, the water-cooled condenser, the chiller, and the heat pump valve may each be horizontally mounted on and coupled to the refrigerant manifold. This configuration may be a preferred embodiment for improving a packaging property of the refrigerant module. The stacking direction of the refrigerant manifold 100 may be perpendicular to the direction of gravity.

Here, as the refrigerant ports of the refrigerant manifold are disposed on the outermost side of the manifold body, the connectivity and the workability may be enhanced in the installation of the refrigerant module, as described above.

Both the water-cooled condenser 220 and the chiller 230 may be the heat exchangers in which the refrigerant and the coolant exchange heat with each other. The water-cooled condenser 220 and the chiller 230, which are the heat exchangers, may be mounted on the refrigerant manifold 100 and communicate with the refrigerant channel 115. Here, the chiller 230 may be a battery chiller.

Here, the water-cooled condenser 220 and the chiller 230 may be disposed on one side of the refrigerant manifold 100, the multi-way valve 211 may be disposed on the other side, and the multi-way valve 211 may be coupled to the expansion valve 210. The water-cooled condenser 220 and the chiller 210 may be disposed on one side of the refrigerant manifold 100, and the multi-way valve 211 may be disposed on the other side of the refrigerant manifold 100.

This arrangement of the components 200 may efficiently design the formation of the refrigerant channel 115 and the arrangement of the refrigerant ports 120.

The water-cooled condenser 220 may be disposed on the refrigerant manifold 100 to allow a length direction of the water-cooled condenser 220 to be oriented from an upper side to a lower side in the direction of gravity. The water-cooled condenser 220 may be disposed on the refrigerant manifold 100 in the direction of gravity. Here, the length direction of the water-cooled condenser 220 may be oriented to match the direction of gravity.

This configuration is to allow the coolant (liquid) introduced into the water-cooled condenser 220 to flow from top to bottom in the direction of gravity. Here, the gas-phase refrigerant may exchange heat with the coolant as the refrigerant moves from bottom to top.

The multi-way valve 211 may include the plurality of multi-way valves 211, the refrigerant manifold 100 may include the plurality of refrigerant ports 120, and one of the plurality of refrigerant ports 120 may be disposed around one of the plurality of multi-way valves 211.

As described above, the plurality of multi-way valves 211 may be provided, and among these valves, the third multi-way valve 211-3 may determine whether to transfer the refrigerant that passes through the water-cooled condenser 220 to the air-cooled condenser or to bypass the air-cooled condenser. The third multi-way valve 211-3 may be mounted on the third valve accommodation part 110A1-3.

Here, the fifth refrigerant port 120-5 may be the refrigerant port through which the refrigerant flows from the refrigerant manifold 100 to the air-cooled condenser, and the fifth refrigerant port 120-5 may be disposed around the third valve accommodation part 110A1-3 for mounting the third multi-way valve 211-3. This configuration may preferably minimize the refrigerant channels.

The embodiments of the present disclosure have been described hereinabove with reference to the accompanying drawings. However, it should be understood by those skilled in the art to which the present disclosure pertains that various modifications and alterations may be made without departing from the technical spirit or essential feature of the present disclosure. Therefore, it should be understood that the embodiments described above are illustrative rather than restrictive in all aspects.

1. A refrigerant manifold comprising:
a manifold body having components mounted thereon and including a refrigerant channel formed therein through which a refrigerant flows; and
a refrigerant port communicating with the refrigerant channel to introduce the refrigerant from the outside or discharge the refrigerant to the outside,
wherein at least one of the refrigerant ports is disposed on an outermost side of the manifold body.

2. The refrigerant manifold of claim 1, wherein the manifold body has a plate-like shape,
a component mounting structure for mounting the components is formed on each of one surface and the other surface of the manifold body,
an engraved structure forming the refrigerant channel is formed on an inner surface of the manifold body, and
the refrigerant port is disposed on a surface other than the surface on which the refrigerant channel is formed.

3. The refrigerant manifold of claim 2, wherein the manifold body includes a first housing, a central plate, and a second housing, each having a plate-like shape, and
the first housing, the central plate, and the second housing are sequentially stacked.

4. The refrigerant manifold of claim 3, wherein the central plate is a flat plate having one flat surface and the other flat surface,
the engraved structure forming the refrigerant channel is formed on each of an inner side of the first housing and an inner side of the second housing, and
the refrigerant channels are formed between the first housing and the central plate, and between the second housing and the central plate.

5. The refrigerant manifold of claim 4, wherein the component mounting structures for mounting the components are disposed on an outer side of the first housing, which is the one surface of the manifold body, and an outer side of the second housing, which is the other surface of the manifold body, respectively.

6. The refrigerant manifold of claim 4, wherein the central plate includes at least one through hole passing through the central plate, and
a first refrigerant channel and a second refrigerant channel communicate with each other through the through hole in the central plate if, among the refrigerant channels, the refrigerant channel formed between the first housing and the central plate is referred to as the first refrigerant channel, and the refrigerant channel formed between the second housing and the central plate is referred to as the second refrigerant channel.

7. The refrigerant manifold of claim 6, wherein the through hole in the central plate enables a direct flow of the refrigerant between a first component and a second component if, among the components, the component mounted on an outer side of the first housing, which is the one surface of the manifold body, is referred to as the first component, and the component mounted on an outer side of the second housing, which is the other surface of the manifold body, is referred to as the second component.

8. The refrigerant manifold of claim 3, wherein the first housing includes a fifth refrigerant port and a sixth refrigerant port,
the second housing includes a first refrigerant port, a second refrigerant port, a third refrigerant port, and a fourth refrigerant port, and
a port hole in the first refrigerant port has a larger diameter than any of port holes in the second to sixth refrigerant ports.

9. The refrigerant manifold of claim 8, wherein the sixth refrigerant port is disposed at a lowest position among the refrigerant ports in a direction of gravity.

10. The refrigerant manifold of claim 8, wherein at least some of the refrigerant ports have the port holes in the refrigerant ports that are open in a direction perpendicular to a direction in which the manifold bodies are stacked.

11. The refrigerant manifold of claim 8, wherein the refrigerant port includes more port holes that are open in a direction parallel to a stacking direction of the manifold bodies than the port holes in the refrigerant port that are open in a direction perpendicular to the stacking direction of the manifold bodies.

12. A refrigerant module comprising:
a refrigerant manifold as claimed in claim 1; and
components mounted on and coupled to the refrigerant manifold,
wherein the components include an expansion valve, a water-cooled condenser, a chiller, and a heat pump valve,
the plurality of expansion valves are provided, each expansion valve being mounted on one surface of the refrigerant manifold, and
the water-cooled condenser, the chiller, and the heat pump valve are mounted on the other surface of the refrigerant manifold.

13. The refrigerant module of claim 12, wherein a direction in which the refrigerant manifolds are stacked is perpendicular to a direction of gravity.

14. The refrigerant module of claim 13, wherein the water-cooled condenser and the chiller are disposed on one side of the refrigerant manifold,
a multi-way valve is disposed on the other side, and
the multi-way valve is coupled to the expansion valve.

15. The refrigerant module of claim 13, wherein the water-cooled condenser is disposed on the refrigerant manifold to allow a length direction of the water-cooled condenser to be oriented from an upper side to a lower side in the direction of gravity.

16. The refrigerant module of claim 14, wherein the multi-way valve includes the plurality of multi-way valves,
the refrigerant manifold includes a plurality of refrigerant ports, and
one of the plurality of refrigerant ports is disposed around one of the plurality of multi-way valves.

17. The refrigerant module of claim 16, wherein among the plurality of multi-way valves, a fifth refrigerant port among the plurality of refrigerant r ports is disposed around a third valve accommodation part among valve accommodation parts respectively accommodating the plurality of multi-way valves.
